(19) United States
(12) Patent Application Publication
(10) Pub. No.: US 2015/0322859 A1
(43) Pub. Date: Nov. 12, 2015

(54) GAS TURBINE AIR INLET ARRANGEMENT AND METHODS

(71) Applicant: DONALDSON COMPANY, INC., Minneapolis, MN (US)

(72) Inventors: THOMAS VAN DEN BOSSCHE, Korbeek-Lo (BE); Erwin Jean Marie Verbelen, Meise (BE)

(21) Appl. No.: 14/706,291

(22) Filed: May 7, 2015

Related U.S. Application Data
(60) Provisional application No. 61/991,891, filed on May 12, 2014.

(51) Int. Cl. F02C 7/055

(52) U.S. Cl. CPC F02C 7/055

(57) ABSTRACT

A tube sheet for the air intake for a gas turbine includes a non-planar frame arrangement with openings to receive filter elements. There can be inlet hoods that are pivotable relative to the tube sheet.

### CROSS-REFERENCE TO RELATED APPLICATION

This application claims the benefit of provisional application Ser. No. 61/991,891, filed May 12, 2014, which is incorporated herein by reference in its entirety.

### TECHNICAL FIELD

This disclosure concerns air filtration. In particular, this disclosure concerns a tube sheet arrangement for use in air filtration in various systems including, for example, gas turbines, compressors, dust collectors, etc.

### BACKGROUND

Although this disclosure may be used in a variety of applications, it was developed for use with gas turbine filter systems. One such system is described in U.S. Pat. No. 6,368,386, incorporated herein by reference. Gas turbine air filter systems are generally very large systems. Improvements to the prior art are desirable, including improvement in ease of constructing the systems and decreases to cost.

### SUMMARY

A tube sheet is provided. The tube sheet includes a non-planar frame arrangement including a plurality of openings to operably receive filter elements in covering relation to the openings.

The non-planar frame arrangement can have at least some of the openings be generally co-planar and at least some of the openings be generally non-coplanar with each other.

The non-planar frame arrangement can have an alternating off-set.

The non-planar frame arrangement can have at least some of the openings be recessed relative to others of the openings.

The frame arrangement may include first frame members oriented in a first direction and second frame members oriented in a second direction perpendicular to the first direction. At least some of the first frame members are recessed relative to other first frame members.

The tube sheet can include a plurality of arrays of openings, and at least some of the arrays are recessed relative to the other arrays.

The arrays may alternate between being recessed and not being recessed, such that a recessed array is immediately between two adjacent non-recessed arrays.

The tube sheet can include a plurality of columns of openings, and the arrays include the columns.

The tube sheet may include a plurality of columns of openings, and at least some of the columns are recessed relative to the other columns.

The columns can alternate between being recessed and not being recessed, such that a recessed column is immediately between two adjacent non-recessed columns.

In some arrangements, the tube sheet includes a plurality of rows of openings.

In at least some rows, the frame arrangement defining the openings alternate between being recessed and non-recessed.

An air intake for a gas turbine system includes a tube sheet, as characterized above. A plurality of filter elements is operably installed to cover the openings.

Filter elements may comprise at least one of pocket filters, panel filters, or cylindrical filters.

The air intake may further include a plurality of hoods secured to a frame containing the tube sheet.

The hoods can be selectively moveable from a position oriented against the tube sheet to a position projecting from the tube sheet.

In some systems, the tube sheet can comprise an upstream tube sheet, and there can further be a downstream tube sheet, spaced from and downstream of the upstream tube sheet.

The downstream tube sheet can be generally a planar frame arrangement including a plurality of openings to operably receive filter elements in covering relation to the openings. A plurality of filter elements can be operably covering the downstream tube sheet openings.

An air intake for a gas turbine system can include a tube sheet having a plurality of openings to operably receive filter elements in covering relation to the openings, and a plurality of hood arrangements pivotably secured a frame containing the tube sheet. The hood arrangements can be moveable from a first position oriented against the tube sheet to an operating position projecting from the tube sheet.

Each of the hood arrangements may include an upper hood and a pair of side hoods. The upper hood can be above one of the tube sheet openings, and each side hood can extend along a side of one of the openings.

It is noted that not all these specific features described herein need to be incorporated in an arrangement for the arrangement to have some selected advantage according to the present disclosure.

### BRIEF DESCRIPTION OF THE DRAWINGS

FIG. 1 is a schematic, cross-sectional view of a gas turbine air intake filtration system;

FIG. 2 is a schematic, perspective view of an embodiment of an air intake usable with the system of FIG. 1, constructed in accordance with principles of this disclosure;

FIG. 3 is a perspective view of a tube sheet used in the air intake of FIG. 2, shown adjacent to a standard tube sheet;

FIG. 4 is a cross-sectional view of the tube sheets of FIG. 3, the cross-section being taken along the line A-A of FIG. 3;

FIG. 5 is a schematic, perspective view of the air intake of FIG. 1, but with the hood arrangement and filter elements removed for purposes of illustration;

FIG. 6 is a schematic, perspective view of the tube sheet used in the air intake of FIG. 5;

FIG. 7 is a schematic, perspective view of a portion of the air intake system of FIG. 2, and showing the hood arrangement partially folded;

FIG. 8 is a schematic, perspective view of the air intake of FIG. 7, and showing the hood arrangement folded against the tube sheet;

FIG. 9 is a schematic, perspective view of a portion of the intake system of FIG. 7;

FIG. 10 is a schematic, perspective view of the air intake system of FIG. 7; and

FIG. 11 is a schematic, perspective view of another embodiment of an air intake usable with the system of FIG. 1, constructed in accordance with principles of this disclosure.

### DETAILED DESCRIPTION

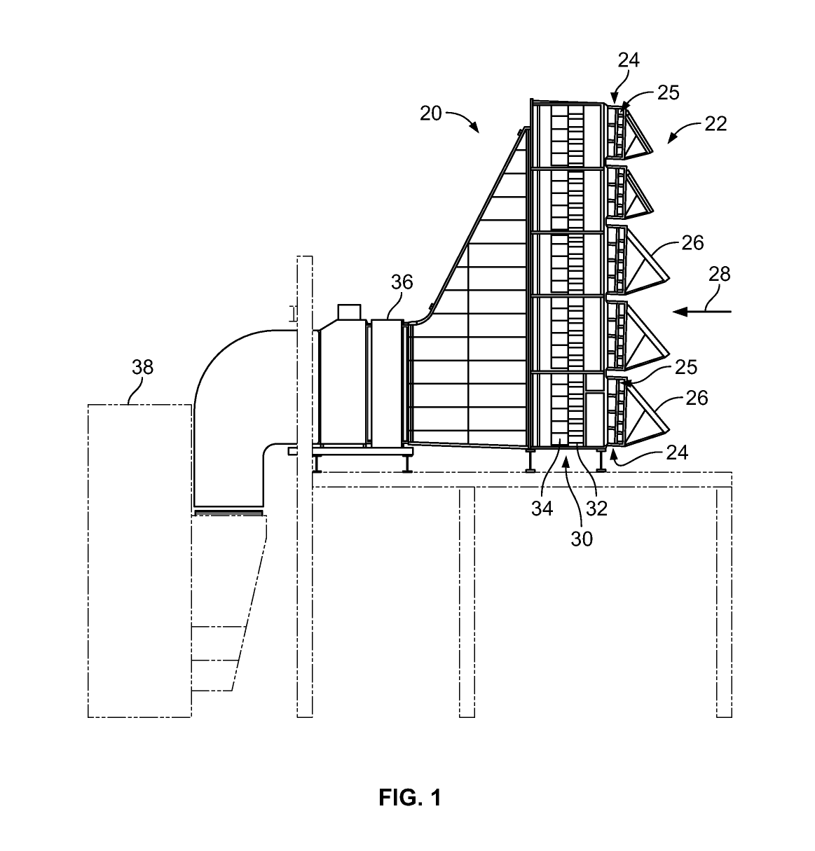

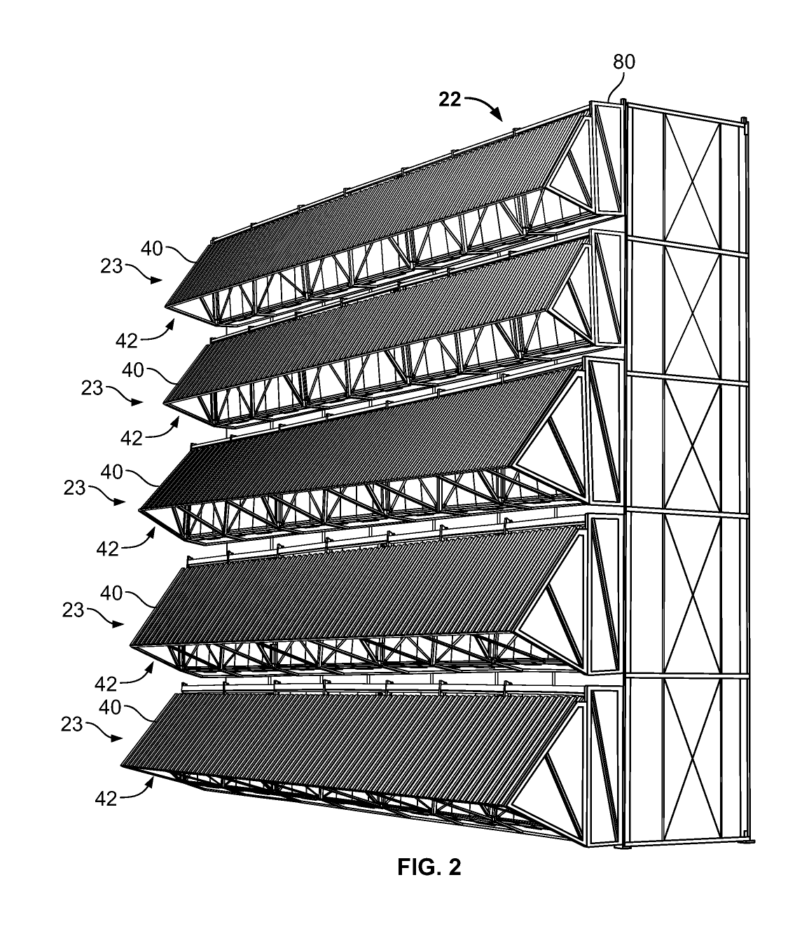

In FIG. 1, a schematic depiction of a gas turbine air intake filtration system is shown at 20. The system 20 can include an air intake 22, also depicted in FIG. 2.

The air intake 22 can include a first stage filtration arrangement 24, under inlet hoods 26 (FIGS. 1 and 2). In FIG. 1, air enters the system 20 in the direction of arrow 28. The air enters underneath the inlet hoods 26 and then flows through the first stage filtration system 24. From there, the air flows to a second stage filtration arrangement 30, which can be in the form of a pair of filter elements. For example, the filter element pair can include two cylindrical elements 32, 34. The cylindrical elements 32, 34 are coaxially aligned and connected end-to-end in a sealed manner. In other systems, the filter element pair will include a cylindrical element and a truncated conical element, coaxially aligned and connected end-to-end in a sealed manner.

In one or more example embodiments, upstream of the first stage filtration arrangement 24 and after the inlet hoods 26 is a droplet catcher arrangement 25. The droplet catcher arrangement 25 is used as an inertial separator, to catch water droplets from the air intake and separate the water droplets from the air that flows downstream to the first stage filtration arrangement 24. One useful droplet catcher arrangement 25 is a drift eliminator of the type sold by Brentwood Industries and described at www.brentwoodindustries.com/products/cooling-tower/drift-elimnators/. Another useful droplet catcher arrangement 25 is described in U.S. Pat. No. 6,544,628, incorporated herein by reference.

After passing through the second stage filter arrangement 30, the filtered air is directed through duct work 36. From the duct work 36, the air flows to the gas turbine 38.

The system 20 depicted in FIG. 1 is a static system, in that it does not include features for cleaning the filter elements. In alternate systems, there can be a reverse pulse cleaning system, which will periodically send pulses of air to the second stage filter arrangement 30 to clean the elements.

In FIG. 2, the air intake 22 is depicted in a schematic, perspective view. In the example embodiment of FIG. 2, there are five rows of air inlets 23 depicted. In many embodiments, there will be more or fewer rows, than those depicted herein. In the rows of air inlets 23, inlet hoods 40 are visible. The hoods 40, in the example shown, are foldable. The foldable hoods 40 help to contribute to convenient shipping and assembly. This is described further below. The hoods 40 can be secured to an air inlet frame 80, which contains or holds a tube sheet 44.

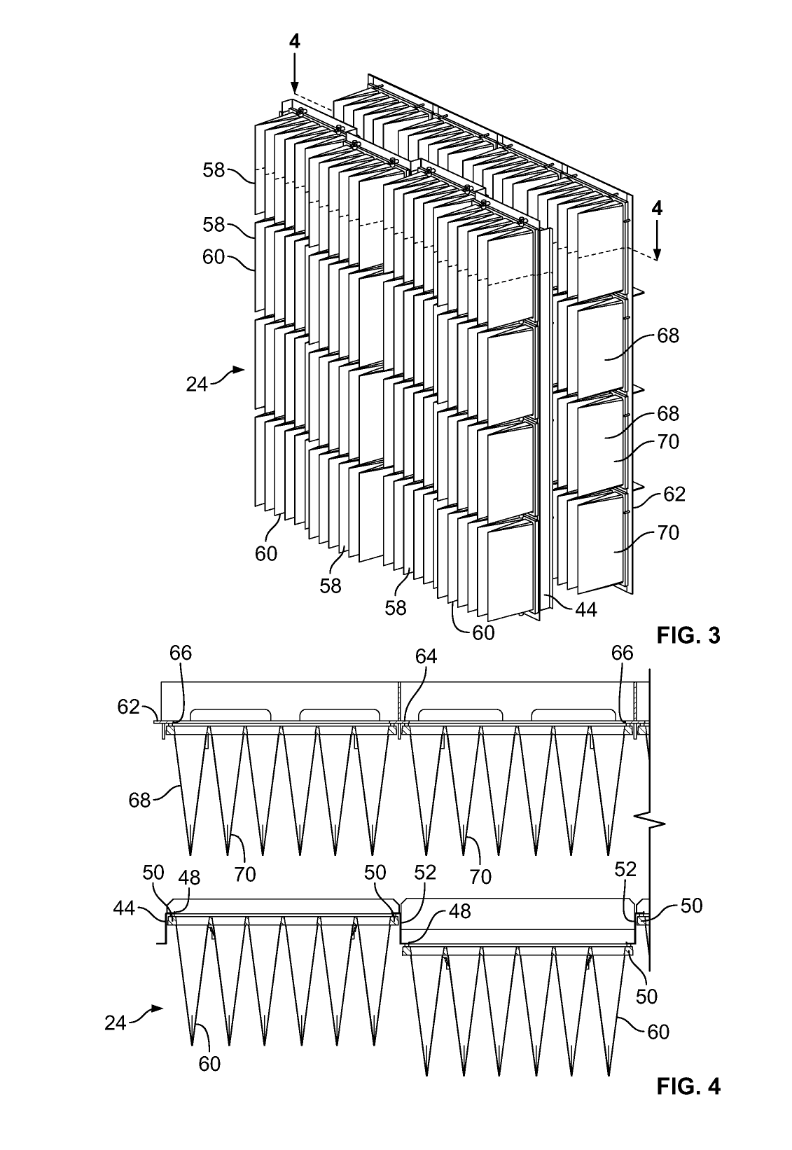

Underneath each of the hoods 40 is an air inlet path 42. Air to be filtered will be taken in through the air intake, and will flow through the air inlet 42 underneath the hoods 40. Behind each of the hoods 40 is the first stage filtration arrangement 24 (FIG. 3).

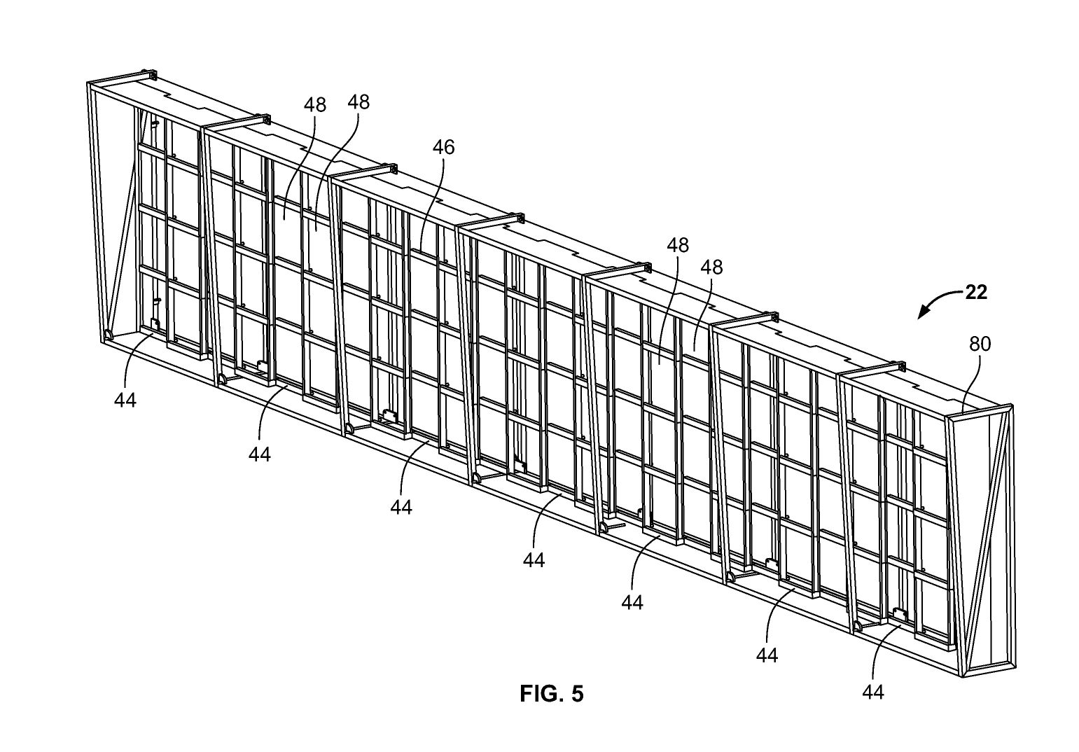

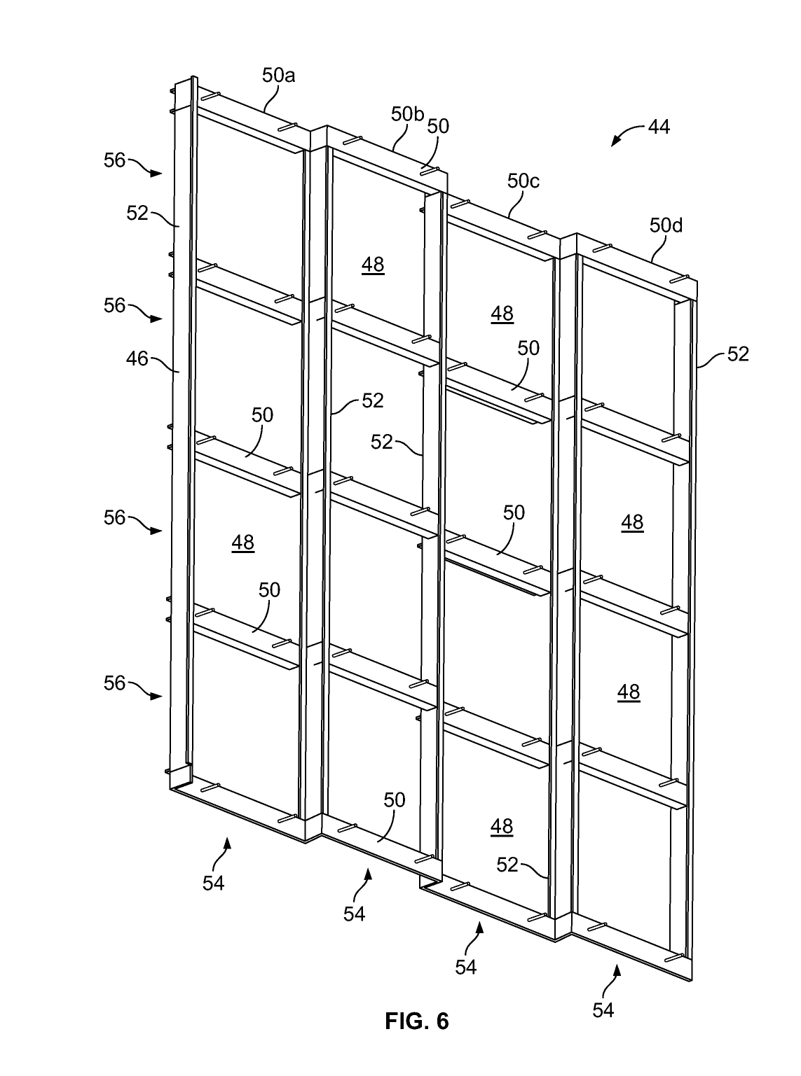

The first stage filtration arrangement 24 includes tube sheet 44. In this example embodiment, the tube sheet 44 includes a non-planar frame arrangement 46 (FIGS. 5 and 6). The frame arrangement 46 defines or includes a plurality of openings 48. The openings 48 are sized and configured to operably receive filter elements 58 that are part of the first stage filtration system 24.

Referring now to FIG. 6, the frame arrangement 46 includes first frame members 50. The first frame members 50 are oriented in a first direction. In the embodiment shown in FIG. 6, the first frame members 50 are oriented in a generally horizontal direction. In other arrangements, the first frame members 50 can be oriented in a different direction.

The frame arrangement 46 further includes second frame members 52. The second frame members 52 are oriented in a second direction perpendicular to the first direction of the first frame members 50. In the example shown in FIG. 6, the second frame members 52 are oriented vertically. In FIG. 4, it can be seen how, in this example arrangement, the second frame members 52 are generally Z-shaped to connect adjacent ones of the first frame member 50.

From a review of FIG. 6, it can be seen that at least some of the first frame members 50 are recessed relative to other of the first frame members 52. For example, in FIG. 6, frame member 50a is recessed relative to frame member 50b. Frame member 50c is recessed relative to frame member 50b and relative to frame member 50d.

The tube sheet 44 includes a plurality of columns 54 of openings 48. At least some of the columns 54 are recessed relative to the other columns 44.

In the example shown, the columns 54 alternate between being recessed and not being recessed, such that a recessed column 54 is immediately between two adjacent non-recessed columns 54. For example, the column 54 that contains first frame member 50c is immediately between the column 54 containing first frame member 50b and the column 54 containing first frame member 50d, and is also recessed between the column 54 containing first frame member 50b and the column 54 containing first frame member 50d. The column 54 containing first frame member 50a is recessed relative to column 54 containing first frame member 50b. Other embodiments are possible.

The tube sheet 44 includes a plurality of rows 56 of openings 48. In at least some rows 56, the frame arrangement 46 defines openings 48 that alternate between being recessed and non-recessed. In one or more example embodiments, the non-planar frame arrangement 46 has at least some of the openings 48, and not all of the openings 48, as co-planar.

In reference to FIGS. 4 and 6, the first frame members 50 and second frame members 52 define the openings 48. While many different embodiments are possible, in the example shown, the openings 48 in adjacent columns 54 are off-set and not co-planar. By “off-set”, it is meant that the openings are not contained in a single plane but they can be parallel. In the example shown, every other column 54 has openings 48 that are generally co-planar. By “generally co-planar”, it is meant that the openings 48 are contained in the same plane or within about an inch of being in the same plane.

It should be understood that while the embodiment of FIG. 6 shows the openings 48 in each column 54 to be generally co-planar, with the adjacent column 54 off-set, the tube sheet 44 could be made such that: the openings 48 in each row would be generally co-planar, with the adjacent row being off-set.

An alternate way of viewing the tube sheet 44 is in terms of a first set of arrays and a second set of arrays. That is, the tube sheet 44 can have the first set of generally parallel arrays and the second set of generally parallel arrays, with the first set of arrays and second set of arrays being generally perpendicular to each other. For example, each row 56 can be in the first set of arrays, and each column 54 can be the second set of arrays. The tube sheet 44 has one of the first and second sets of arrays with openings 48 that are generally co-planar within the array of that set of arrays, and the other of the first and second sets of arrays with openings 48 that are alternating off-set within the array for that set of arrays. In other words, the tube sheet 44 includes a plurality of arrays of openings 48, and at least some of the arrays are recessed relative to the other arrays. For example, the arrays can alternate between being recessed and not being recessed, such that a recessed array is immediately between two adjacent non-recessed arrays.

The off-set between an opening 48 in one column 54 relative to the opening 48 in an adjacent column 54 can be generally measured by the length of the second frame members 52, in extension between adjacent first frame members (see FIG. 4). While many different embodiments are possible, it has been found that an offset of at least 60 mm, not greater than 100 mm, and typically about 75-85 mm is useful. The frame members 52 are structurally similar to I-beams, and if made too long, e.g., greater than 100 mm, there will be buckling under load. If made too short, e.g., less than 60 mm, they will be too weak and deflect under load.

In one or more preferred embodiments, the tube sheet 44 can be characterized as having an alternating off-set. By “alternating off-set”, it is meant that a first opening 48 along at least one of the directions (rows 56 or columns 54) is off-set (non coplanar) relative to the opening 48 immediately adjacent to it in that direction (rows 56 or columns 54), while the next opening 48 is generally co-planar to the first opening 48.

FIG. 5 illustrates the tube sheet 44 held within a portion of the air inlet 22. In this example, the tube sheet 44 is held within air inlet frame 80. The air inlet frame 80 of FIG. 5 is depicted without hoods 40 and without filter elements 58, for purposes of illustration. In this example, the tube sheet 44 has four columns 54 and is secured, such as by welding, to another tube sheet 44. FIG. 5 shows seven tube sheets 44 secured horizontally to each other to form the air intake 22.

In reference again to FIGS. 3 and 4, the first stage filtration arrangement 24 is depicted. The first stage filtration arrangement 24 includes a plurality of filter elements 58. The filter elements 58 can be removably and replaceably operably installed in the air intake 22 to cover the openings 48 (FIG. 6) in the tube sheet 44.

The elements 58 may comprise at least one of pocket filters, panel filters, or cylindrical filters. In the embodiment shown in FIGS. 3 and 4, pocket filters 60 are depicted. The pocket filters 60 can include the appropriate filter media, such as cellulose. The media could also be water repellant, using materials such as PTFE. The media could also include fiber glass media, synthetic media, or many other variations and blends.

FIGS. 3 and 4 show the tube sheet 44 adjacent to a standard tube sheet 62.

The standard tube sheet 62 has a generally planar frame arrangement 64. The frame arrangement 64 includes a plurality of openings 66 to operably receive filter elements 68 in covering relation to the openings 66. A plurality of the elements 68 removably, replaceably, and operably cover the tube sheet openings 66. In the example shown in FIGS. 3 and 4, the elements 68 are pocket filters 70.

The non-planar tube sheet 44 leads to advantages. For example, more filter elements 58 may be installed in any given width, when compared to planar tube sheets. In one example, 25 elements were able to be installed in a fixed width, instead of the previous 24, representing a gain of 4%.

Another advantage includes the reduction in welding and weight when using the non-planar tube sheet 44. For the non-planar tube sheet 44, the weight is less than half of the weight of the standard planar tube sheet 62. In one example, the non-planar tube sheet 44 has a weight of about 51 kilograms per 16 standard 2 ft×2 ft elements, as compared to the weight of the standard, planar tube sheet 62 of 116 kilograms per 16 standard 2 ft×2 ft elements. With respect to the welds needed, the non-planar tube sheet 44 will have 48 meters less welding to be done than for the planar tube sheet 62, per 16 standard 2 ft×2 ft elements. This corresponds to at least 8 hours of welding. This results in substantial savings in labor and material.

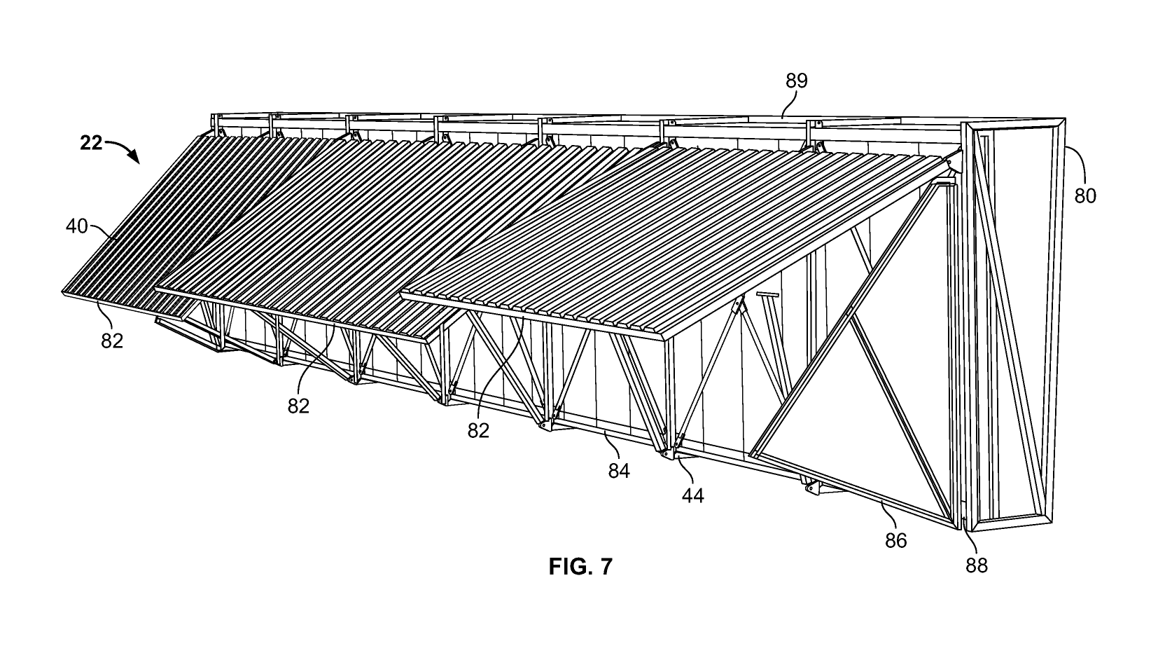

In reference now to FIGS. 2 and 7-10, the air intake 22, as previously mentioned, can include hood arrangements 40. FIGS. 7-10 depict schematic examples of a portion of the air intake 22 having hood arrangements 40.

The hood arrangements 40 are pivotably secured to the air inlet frame 80. The frame 80 holds or contains the tube sheet 44. In other embodiments, the hood arrangements 40 can be used with inlet frames 80 holding standard, planar tube sheets 62.

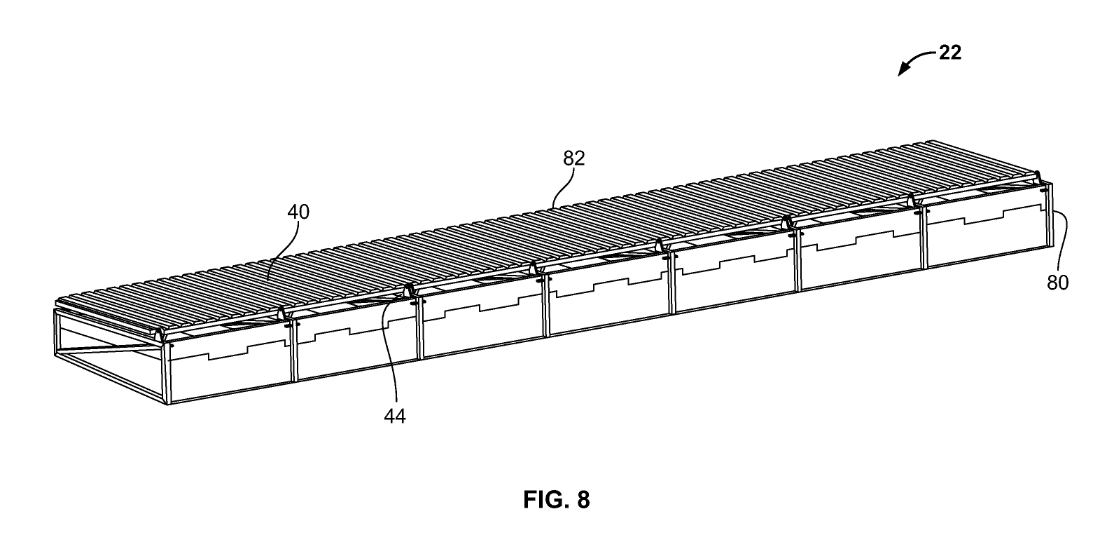

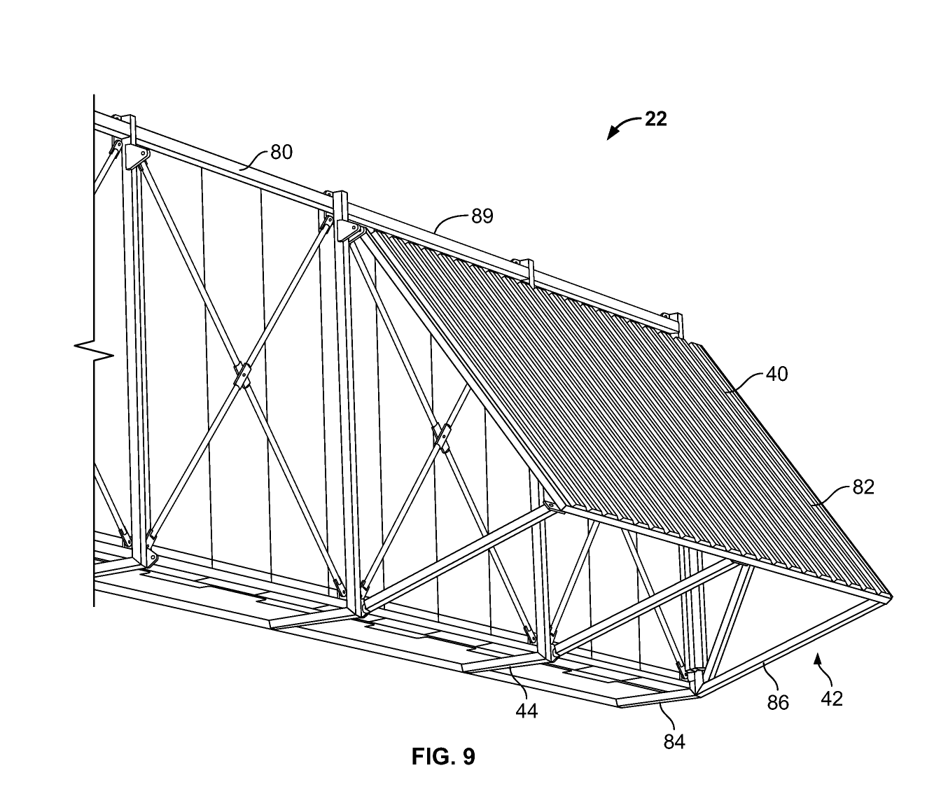

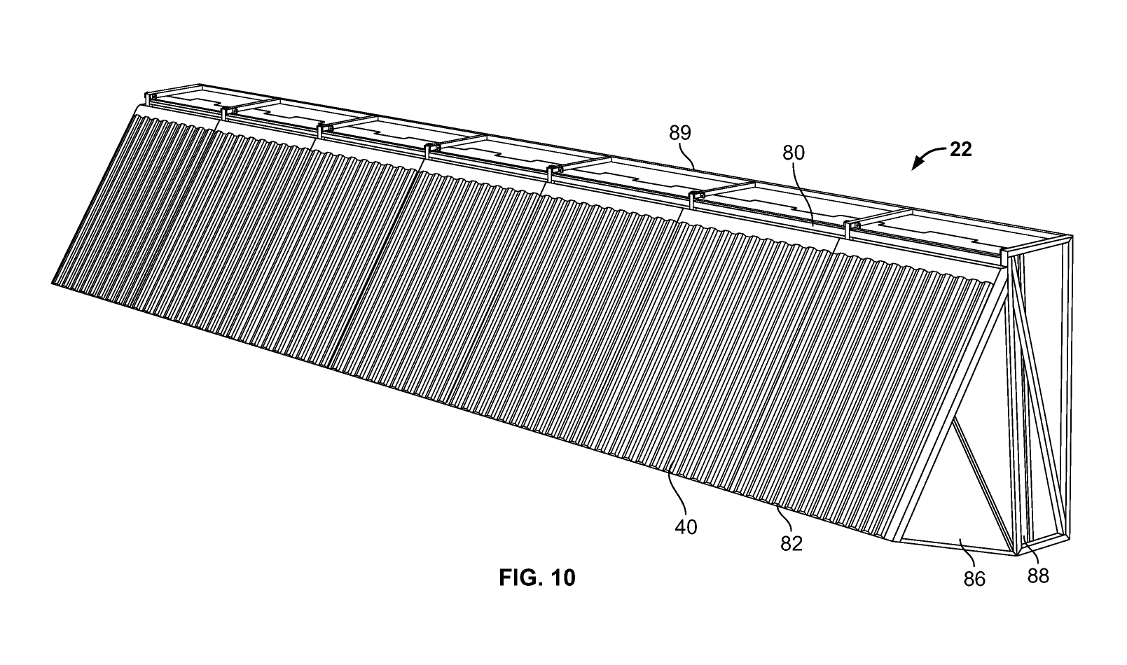

The hood arrangements 40 are movable from a first position oriented against the tube sheet 44 (FIG. 8) to an operating position (FIGS. 9 and 10) projecting from the tube sheet 44.

In the examples shown, each of the hood arrangements 40 includes an upper hood 82. The upper hoods 82 are above at least one of the tube sheet openings 84 (FIGS. 7 and 9).

The hood arrangements 40 can also include at least one hood side 86 extending along a side of one of the tube sheet openings 84. In the example shown in FIGS. 9 and 10, the hood side 86 extends from the tube sheet 80, along side 88, generally perpendicular to the upper side 89 from where the upper hood 82 is extending. The hood side 86, in the example shown in FIG. 9, extends between the tube sheet 80 and the upper hood 82. In the example shown, the hood side 86 is generally triangular shaped. Other embodiments are possible.

In general, each horizontal row in the tube sheet 80 can have at each opposite end hood side 86.

FIG. 8 shows the upper hoods 82 and hood sides 86 in the first position oriented against the tube sheet 80. In this position, the tube sheet 80 can be shipped and then easily and quickly installed on site by moving the upper hood 82 and hood side 86 into the operating position projecting from the tube sheet 80.

FIG. 7 shows three upper hoods 82 in various stages between the first position, oriented against the tube sheet 80 and the operating position, shown in FIG. 10. The upper hoods 82 can be moved from their first position of FIG. 8 by pivoting the upper hoods 82 relative to the tube sheet 80, as shown in FIG. 9. The hood sides 86 can similarly be pivoted from the sides 88 to the operating position shown in FIGS. 9 and 10. This leads to advantages in manufacturing, shipping, and assembly.

In operation, air to be filtered in the system 20 will first pass into the air intake 22 by going through the air inlets 42 (FIG. 9) underneath the hood arrangements 40. The hood arrangements 40 can include pivotable upper hoods 82 and pivotable hood sides 86.

From there, the air will pass through the droplet catcher arrangement 25, where at least some moisture is removed from the air. After passing through the droplet catcher arrangement 25, the air flows to the first stage filter arrangement 24. The air will pass through the first stage filter arrangement 24. In embodiments having the non-planar tube sheet 44, the air will pass through elements 58 held by the non-planar tube sheet 44. As such, the air will pass through the elements 58, some of the elements 58 being recessed relative to the other elements 58.

From there, the air can pass through the second stage filter arrangement 30, and then into the duct work 36, and then to the gas turbine 38. In embodiments having a self-cleaning feature, the second stage filter arrangement 30 can be reverse-pulse cleaned.

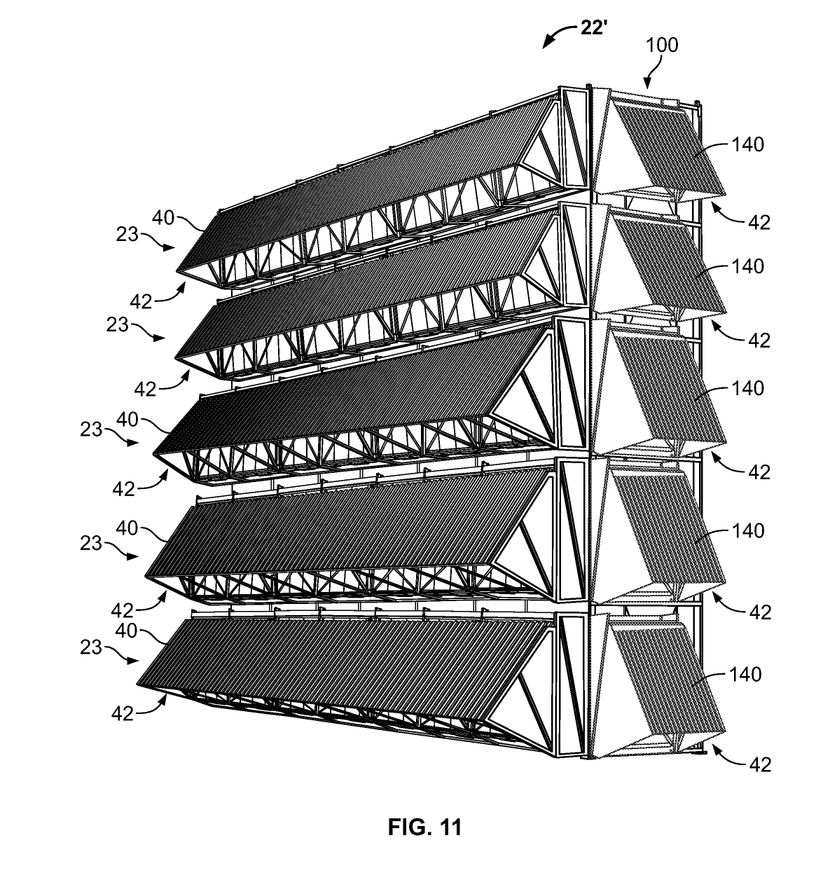

FIG. 11 illustrates an alternate embodiment, depicted as air intake 22′. Air intake 22′ is similar to the arrangement of FIG. 2 in that there are five rows of air inlets 23 depicted, but there can be more or fewer rows, than those shown. In the rows of air inlets 23, inlet hoods 40 are visible. The hoods 40, in the example shown, are foldable. The hoods 40 can be secured to air inlet frame 80, which contains or holds tube sheet 44. Underneath each of the hoods 40 is air inlet path 42. Air to be filtered will be taken in through the air intake, and will flow through the air inlet 42 underneath the hoods 40. Behind each of the hoods 40 is the first stage filtration arrangement 24 (FIG. 3).

In the embodiment of FIG. 11, the air intake 22′ has a column 100 of air inlets, in which side inlet hood 140 are visible. The column 100 of air inlets is generally orthogonal to the air inlets arranged in the air inlet rows 23. Although not visible in FIG. 11, there can be a column 100 on the opposite side of the air intake 22′ as well. In the column 100, the side inlet hoods 140 can be foldable and secured to air inlet frame 80. Underneath each of the side inlet hoods 40 in the column 100 is air inlet path 42. Air to be filtered will be taken in through the air intake, and will flow through the air inlet 42 underneath the side inlet hoods 140 and flow to the first stage filtration arrangement 24.

The above represents example principles. Many embodiments can be made utilizing these principles.

What is claimed is:

1. A tube sheet comprising:
a non-planar frame arrangement including a plurality of openings to operably receive filter elements in covering relation to the openings; the non-planar frame arrangement having at least some of the openings being generally co-planar and at least some of the openings being generally non-coplanar with each other.

2. The tube sheet of claim 1 wherein:
(a) the frame arrangement includes first frame members oriented in a first direction and second frame members oriented in a second direction perpendicular to the first direction;
(i) at least some of the first frame members being recessed relative to other first frame members.

3. The tube sheet of claim 1 wherein:
(a) the tube sheet includes a plurality of arrays of openings, and at least some of the arrays are recessed relative to the other arrays.

4. The tube sheet of claim 3 wherein:
(a) the arrays alternate between being recessed and not being recessed, such that a recessed array is immediately between two adjacent non-recessed arrays.

5. The tube sheet of claim 3 wherein:
(a) the tube sheet includes a plurality of columns of openings, and the arrays include the columns.

6. The tube sheet of claim 1 wherein:
(a) the tube sheet includes a plurality of rows of openings.

7. The tube sheet of claim 6 wherein:
(a) in at least some rows, the frame arrangement defining the openings alternate between being recessed and non-recessed.

8. An air intake for a gas turbine system, the air intake comprising:
(a) a tube sheet comprising a non-planar frame arrangement including a plurality of openings to operably receive filter elements in covering relation to the openings; the non-planar frame arrangement having at least some of the openings being generally co-planar and at least some of the openings being generally non-coplanar with each other; and
(b) a plurality of filter elements operably installed to cover the openings.

9. The air intake of claim 8 wherein:
(a) the filter elements comprise at least one of: pocket filters, panel filters, or cylindrical filters.

10. The air intake of claim 8 further comprising:
(a) a first plurality of hoods secured to an inlet frame containing the tube sheet.

11. The air intake of claim 10 further including:
(a) a droplet catcher arrangement downstream of the first plurality of hoods.

12. The air intake of claim 10 wherein the first plurality of hoods is selectively movable from a position oriented against the tube sheet to a position projecting from the tube sheet.

13. The air intake of claim 10 further including a column of side inlet hoods secured to the inlet frame and generally orthogonal to the first plurality of hoods.

14. A tube sheet comprising:
a non-planar frame arrangement including a plurality of openings to operably receive filter elements in covering relation to the openings; the non-planar frame arrangement having at least some of the openings being recessed relative to others of the openings.

15. The tube sheet of claim 14 wherein:
(a) the frame arrangement includes first frame members oriented in a first direction and second frame members oriented in a second direction perpendicular to the first direction;
(i) at least some of the first frame members being recessed relative to other first frame members.

16. An air intake for a gas turbine system, the air intake comprising:
(a) a tube sheet having a plurality of openings to operably receive filter elements in covering relation to the openings; and
(b) a first plurality of hood arrangements pivotably secured to an inlet frame containing the tube sheet, the hood arrangements being movable from a first position oriented against the tube sheet to an operating position projecting from the tube sheet.

17. The air intake of claim 16 wherein:
(a) each of the hood arrangements includes an upper hood, the upper hood being above one of the tube sheet openings.

18. The air intake of claim 16 wherein the hood arrangements includes at least one hood side, extending along a side of at least one of the tube sheet openings.

19. The air intake of claim 16 further comprising a column of side inlet hoods secured to the inlet frame and generally orthogonal to the first plurality of hoods arrangements.

20. The air intake of claim 16 wherein:
(a) the tube sheet comprises a non-planar frame arrangement including a plurality of openings to operably receive filter elements in covering relation to the openings; the non-planar frame arrangement having at least some of the openings being recessed relative to others of the openings.
